(19) United States
(12) Patent Application Publication
(10) Pub. No.: US 2022/0371767 A1
(43) Pub. Date: Nov. 24, 2022

(54) DOUBLE GLUE JOINT SYSTEM AND METHOD THEREOF

(71) Applicant: Mike Stec, Greenwood, AR (US)

(72) Inventor: Mike Stec, Greenwood, AR (US)

(21) Appl. No.: 17/747,773

(22) Filed: May 18, 2022

Related U.S. Application Data
(60) Provisional application No. 63/189,901, filed on May 18, 2021.

(51) Int. Cl. B65D 5/02; B31B 50/62

(52) U.S. Cl. CPC B65D 5/0227; B31B 50/624; B31B 2120/302

(57) ABSTRACT

A system and method for a double glue joint is provided. The box is movable between knockdown and assembled configurations. In the knockdown configuration, the box includes a plurality of co-planar panels connected to one another, with a first and last panel each having a free end having a tab. One of these tabs, along with a portion of the panel adjoining the tab, are coated with adhesive. The box is movable to an assembled configuration by folding the panels relative to each other by one or more score lines until the free ends of the first and last panels meet. Utilizing the adhesive, the tab of the last panel is secured to an exterior surface of the first panel while the tab of the first panel is secured to an interior surface of the last panel, thus forming a double glue joint with interior and exterior connections.

### CROSS-REFERENCE TO RELATED APPLICATIONS

This application claims priority pursuant to 35 U.S.C. 119(e) to co-pending U.S. Provisional Patent Application Ser. No. 63/189,901, filed May 18, 2021, the entire disclosure of which is incorporated herein by reference.

### FIELD OF THE INVENTION

The present invention relates generally to boxes. More specifically, the present invention is concerned with a box with a double glue joint.

### BACKGROUND

Standard shipping boxes are made of cardboard or similar paper material which is folded to form a box. Typical boxes are produced from blanks which are cut with a die into a pre-determined pattern. The standard pattern produces a sheet with a variety of panels, cuts, and scoring lines. The most typical box pattern produces a sheet with 4 wall panels separated at least partly by a score line, with a tab extending from one of the panels. The sheet is then folded along the score lines until an interior cavity is formed, with 4 walls defining an interior. The sheet is retained in this configuration by connect the tab to an interior face or exterior face of an adjoining wall when in an assembled configuration and securing the tab by glue, forming a single glue joint which holds the box together at a corner of the interior.

This standard pattern and production is economical. It includes no complicated folds and only requires a single application of adhesive. This simplicity results in quick set-up time for production lines and low material and labor costs. However, the simple and economic nature of this design has its drawbacks, all of which have been a concern within the industry for decades. Notably, this design tends to fail when attempting to ship heavier items. Oftentimes the failure point is the single glue joint, as it provides a natural weak point where shearing forces can cause failure of the glue, the single tab, or the surrounding paper material.

To address this, the industry has introduced an extensive number of variations in sheet patterns, box geometries, materials, and adhesives. New sheet patterns and the resulting box geometries continue to be introduced with the intent of addressing the inherent weaknesses in the paper materials and the glue joint by providing reinforcement for this joint and providing multiple layers of material in weak areas. Other solutions have been to change the material itself, providing for thicker boxes or those made of paper materials which have stronger inherent properties. Additional securing or reinforcement materials also have been added to boxes, such as staples to reinforce joints and plastic bands and wraps to support the structure of the box. Each of these changes have drastic impacts on the economic nature of the basic box design. The added geometries necessitate additional dies for the production line and the need to switch out dies between production runs. Moreover, the differing geometries requires changing the gluing patterns during production. Thicker or alternative materials add materials costs. Typically, changes to provides stronger boxes include a combination of the aforementioned strategies. Such changes require significant time to adjust machinery in the production to accommodate for a significantly changed fabrication process.

Accordingly, it would be advantageous to have a system and method of producing a box with a strengthened glue joint without the need for extensive additional material costs, labor costs, and time costs associated with modifying the assembly line to extensively differing box geometries.

### SUMMARY

The present invention comprises a box with a double glue joint. The box is movable between a breakdown configuration and an assembled configuration. In the breakdown configuration, the box consists of a plurality of panels, with a left-most (first) panel and a right-most panel (last) panel. The panels are separated by scoring lines to assist in folding each panel relative to adjacent panels. A first tab is connected to the first panel, while a second tab is connected to the last panel. The tabs, in some embodiments, are connected to opposing free edges of the first and last panels, respectively. In such a configuration, the first and second tab are positioned at opposite edges of the sheet, with the plurality of panels positioned between them. It will be appreciated that other geometries incorporating the double glue joint herein are considered.

When the box is moved to the assembled configuration, the free ends of the first and last panel are brought together. In doing so, the plurality of panels forms an interior cavity. In this configuration, both the first tab and the second tab are present at the corner where the first and last panel meet. To secure the box in the assembled configuration, one tab is glued to an interior face of the adjoining panel, while the other tab is glued to an exterior face of the adjoining panel. Thus, a glue joint is formed which consists of a securing tab positioned on the interior of the box and one positioned on the exterior of the box. Advantageously, this reinforces the standard glue joint, providing both interior and exterior support without adding significant material (just a single tab and additional glue).

During the manufacturing process, the glue is applied only once. Once the sheet is formed, the glue is applied to one of the tabs panel and additionally applied to a portion of the exterior surface of the panel to which the tab is connected. When securing the box in the assembled configuration, the tab with glue on it is placed against a surface of adjacent panel which does not have glue, while the tab which did not receive glue is placed against the portion of the adjacent panel which did receive glue.

Thus, to switch from a single tab assembly configuration to a double tab assembly configuration of the present invention requires only to modify the glue applicator to apply the exact same width of glue for an additional length and to adjust the die cutter to include an additional, opposing tab.

Advantageously, this provides a strengthened glue joint without the need for extensive additional material costs, labor costs, and time costs associated with modifying the assembly line to extensively differing box geometries. The production line is switched between single and double glue joints in a matter of minutes.

The foregoing and other objects are intended to be illustrative of the invention and are not meant in a limiting sense. Many possible embodiments of the invention may be made and will be readily evident upon a study of the following specification and accompanying drawings comprising a part thereof. Various features and sub combinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION

A preferred embodiment of the invention, illustrative of the best mode in which the applicant has contemplated applying the principles, is set forth in the following description and is shown in the drawings and is particularly and distinctly pointed out and set forth in the appended claims.

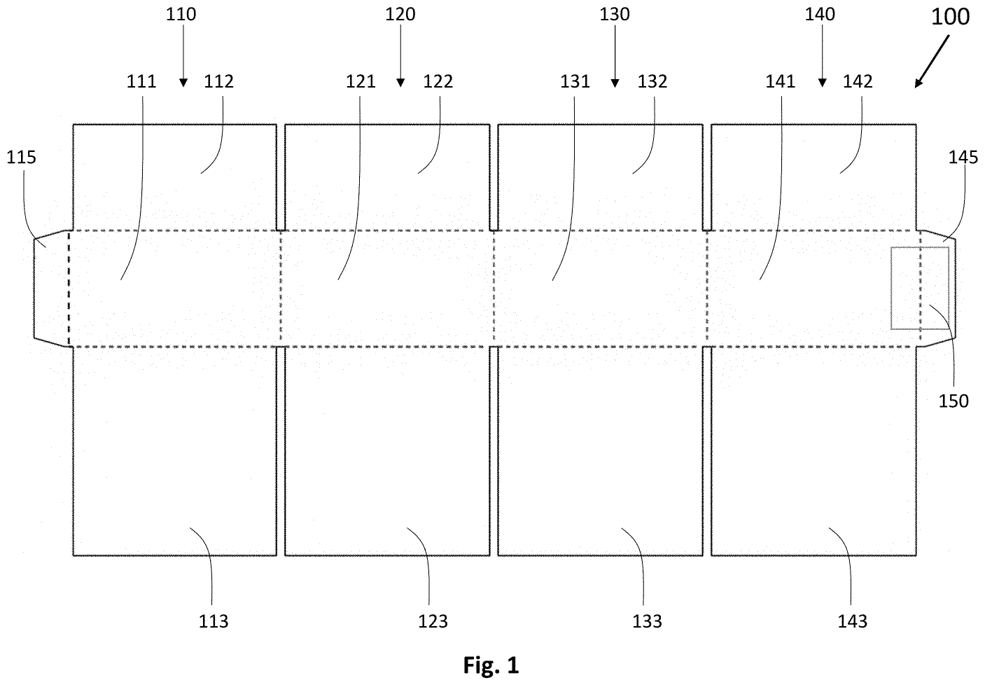

FIG. 1 is a plan view of a sheet and/or box according to one embodiment of the present invention, shown in a knockdown configuration.

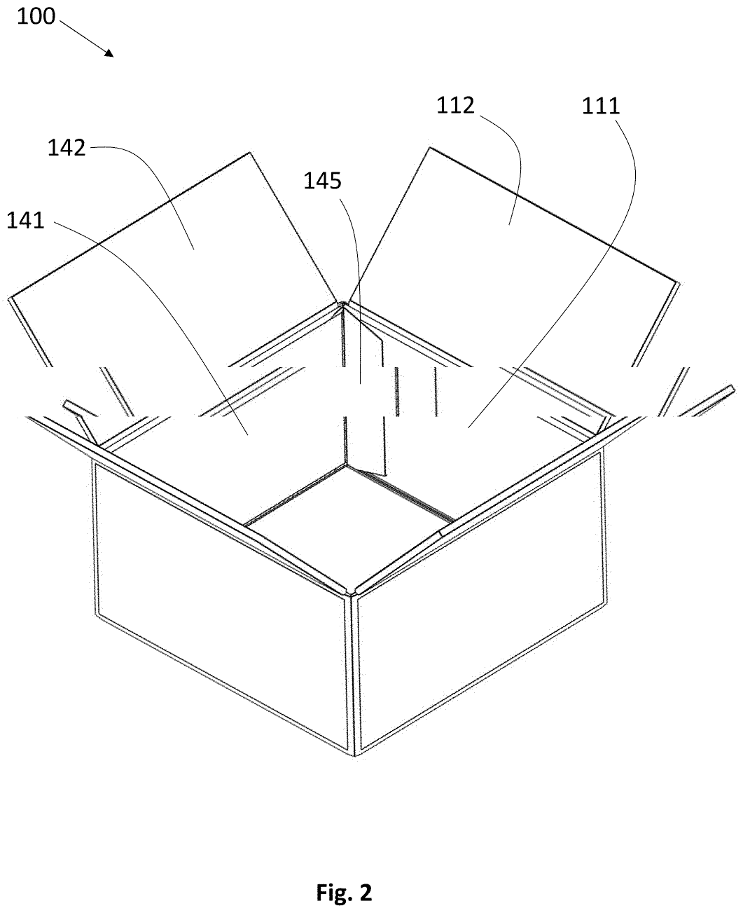

FIG. 2 is a perspective view of a box with a double glue joint according to one embodiment of the present invention, shown in an assembled configuration.

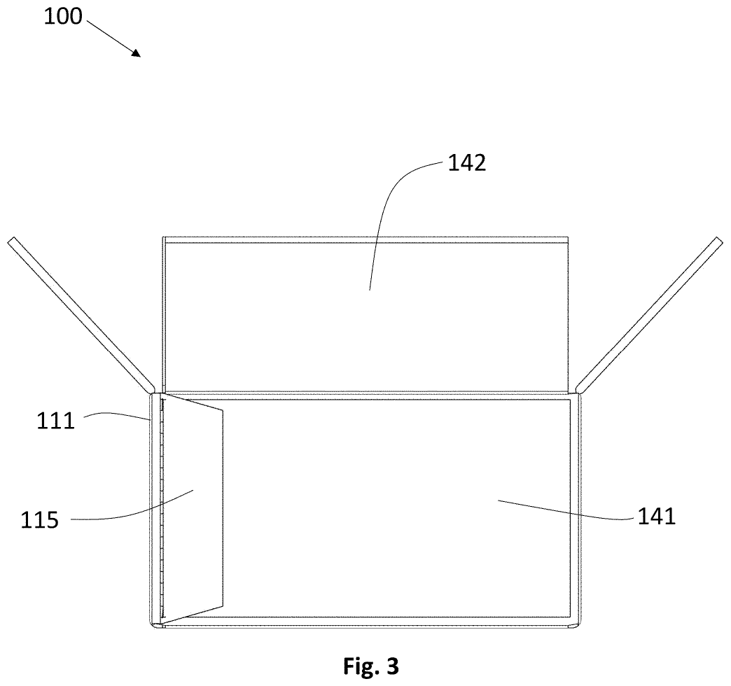

FIG. 3 is a front elevation view of the box of FIG. 2.

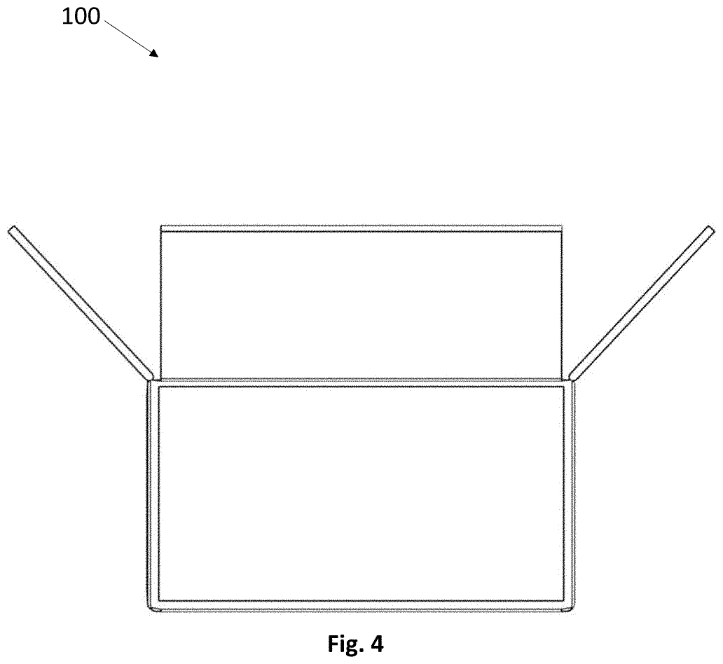

FIG. 4 is a right-side elevation view of the box of FIG. 2, the left-side elevation view and rear-elevation view being substantially similar thereto.

Exhibit A includes photos of a box with a double glue joint, according to one embodiment of the present invention.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

It will be appreciated that the following description discusses an embodiment including a plurality of panel. Specifically, the described embodiment includes four panels, each with corresponding top and bottom portions. It will be appreciated that various number of panels, top portions, and bottom portions are considered, with the geometry of the various portions modified to accommodate for the number of panels. Additionally, it will be appreciated that any shown dimensions, while enabling, are not limiting of the concept to the ascribed dimensions in any way.

Referring to FIG. 1, a box 100 with a double glue joint is provided. In some embodiments, the box 100 is configurable between a knockdown configuration and an assembled configuration. FIG. 1 shows the box 100 in a knockdown configuration, according to some embodiments of the present invention. a sheet of paper material is provided. In the embodiment shown in FIG. 1, the box 100 in a knockdown configuration takes the form of a sheet. In some embodiments, the sheet is formed from a cardboard blank, which is subsequently pressed against a die to cut or otherwise form various panels and features of the box 100. In the exemplary embodiment of FIG. 1, the box 100 is shown with four adjacent panels (110, 120, 130, 140). In some embodiments, each panel (110, 120, 130, 140) has a primary section (111, 121, 131, 141), a top portion (112, 122, 132, 142), and a bottom portion (113, 123, 133, 143).

The left-most panel, also referred to as the first panel 110, is connected to the second panel 120, which is in turn connected to yet another panel, and so on until the penultimate panel 130 (in some embodiments, the third panel) is connected to the last panel 140 (in some embodiments, the fourth panel). In some embodiments, the panels are connected but delineated via one or more score and/or fold lines between each panel. In some embodiments, the score and/or fold lines facilitate easy bending of the panels relative to one another. In some embodiments, one or more of the panels include a middle or primary portion, a top portion, and a bottom portion. In some embodiments, the portions separated by score or other fold lines from one other. In some embodiments, the portions are not separated by score or other fold lines. In some embodiments, only select portions are separated by score and/or fold lines. In some embodiments, the top and bottom portions are separated completely top and bottom portions of adjacent panels, such that only the primary sections of each panel are connected to adjacent panels. In such embodiments, each top and bottom portion is configured to rotate, fold, or otherwise bend relative to the primary section of the same panel, while each panel is configured to rotate, fold, or otherwise bend along the score or other fold lines relative to adjacent panels.

In some embodiments, connected to the first panel 110 is a first tab 115. In some embodiments, connected to the last panel 140 is a second tab 145. In some embodiments, the location of the tab connection is the free edge of the panel—the edge of the panel which does not immediately adjoin another panel. In some embodiments, the tab is connected to the primary portion, while in other embodiments the tab

In some embodiments, the first and second tabs (115, 145) are each configured to be an interior and/or an exterior tab. For the sake the description, the first tab 115 extending from an edge of the first panel will be referred to as an exterior tab and the second tab 145 which extends from an edge of the fourth panel will be referred to as an interior tab. It will be appreciated that these are interchangeable, such as the first tab 115 is an interior tab and the second tab 145 is an exterior tab, or such that the first tab 115 extends from the fourth panel and/or the second tab 145 extends from the first panel. Thus the cutting die is reversable relative to a gluing station during manufacturing.

In some embodiments, the box is configured to move between a knockdown configuration and an assembled configuration. In the knockdown configuration, the main body sits flat while the plurality of panels are co-planar. In some embodiments, moving the box to the assembled configuration including folding one or more of the panels relative to adjacent panels about one or more score lines until the free edges of the first and last panel are positioned adjacent one another. In some embodiments, in this configuration, the panels form an interior cavity and each panel has an interior surface and an exterior surface relative to the cavity, such as can be seen in FIGS. 2-4. In some embodiments, the first tab 115, or exterior tab, extending from the first panel 110 is secured to the exterior surface of the fourth panel 140. In some embodiments, the second tab 145, or interior tab, extending from the fourth panel 140 is secured to an interior surface of the first panel 110.

In some embodiments, the interior 145 and exterior tabs 115 are secured to the respective interior and exterior surface of the adjacent first 110 and last 140 panels via an adhesive 150. In some embodiments, the adhesive is a glue. In some embodiments, the glue is applied to the box during production. In some embodiments, the glue is applied to a portion of one or more panel and a portion of one or more tab. In some embodiments, the glue is applied to the first tab 115 and a portion of the first panel 110, such as the primary section 111, top portion 112, and/or bottom portion 113. In some embodiments, the glue is applied to the second tab 145 and a portion of the fourth panel 140, such as the primary section 141, top portion 142, and/or bottom portion 143, such as can been seen towards the upper portion of FIG. 1. It will be appreciated that moving of the box from its knockdown configuration to its assembled configuration is achieved when the glue is placed on either the first 115 or the second tab 145 and its respective adjoining panel, as the tabs can function as either interior or exterior tabs.

In some embodiments, a method for manufacturing a box is provided. In some embodiments, the method includes cutting a blank. In some embodiments, the blank is cut using one or more pre-formed die. In some embodiments, cutting the blank creates one or more score lines, panels, score and/or fold lines, and tabs in the blank, converting the blank into a box in a knockdown configuration. In some embodiments, the method of manufacture includes applying glue to at least a portion of a tab and a portion of an adjoining panel. In some embodiments, the method further including moving the box from a knockdown to an assembled configuration. In some embodiments, the box includes the various panels, tabs, and other features as described herein. In some embodiments, the box includes the various panels, tabs, and other features as described herein.

In some embodiments, a method for assembling a box is provided. In some embodiments, the method begins with a box in a knockdown configuration. In some embodiments, one or more panel is folded along one or more score line until the free ends of the first and last panels meet. Utilizing the adhesive, the tab of the last panel is secured to an exterior surface of the first panel while the tab of the first panel is secured to an interior surface of the last panel. In some embodiments, the method includes forming a double glue joint with interior and exterior connections via the two tabs.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A container, the container comprising:
a first panel,
a plurality of intermediary panels, wherein one of said plurality of intermediary panels is connected to said first panel,
a last panel, said last panel connected to one of said plurality of intermediary panels,
a first tab connected to at least a portion of the first panel, and
a second tab connected to at least a portion of the last panel.

2. The container as claimed in claim 1, further comprising an adhesive applied to one of the first tab and the second tab.

3. The container as claimed in claim 2, each of the first panel, last panel, and each of the plurality of intermediary panels comprising a primary section, a top section, and a bottom section.

4. The container as claimed in claim 3, wherein the first tab is connected to the primary section of the first panel and the second tab is connected to the primary section of the last panel.

5. The container as claimed in claim 4, wherein said adhesive is applied to the second tab and a portion of said primary section of the last panel.

6. The container as claimed in claim 5, wherein the container is movable between a knockdown configuration and an assembled configuration.

7. The container as claimed in claim 6, wherein the first tab is an exterior tab and the second tab is an interior tab, and wherein the second tab is configured to adhere to a portion of the first panel and the first tab is configured to adhere to a portion of the last panel when the container is the in the assembled configuration.

8. The container as claimed in claim 7, wherein the portion of the first panel that the second tab is configured to adhere to is an interior surface of said primary portion of the first panel and wherein the portion of the last panel that the first tab is configured to adhere to is an exterior surface of said primary portion of the last panel.

9. A method of moving a container from a knockdown to an assembled configuration, the method comprising the steps:
folding one or more panels of a plurality of panels relative to one or more adjacent panel of said plurality of panels;
positioning a free end of a first panel adjacent to a free end of a last panel, thereby forming an interior cavity with the plurality of panels; and
securing a first tab of the first panel to an exterior surface of the last panel and securing a second tab of the last panel to an interior surface of the first panel.

10. The method of claim 9, wherein the method further comprises placing a single application of adhesive on the second tab and a portion of the last panel.

11. The method of claim 10, wherein each of the first panel, last panel, and each of the plurality of intermediary panels comprising a primary section, a top section, and a bottom section.

12. The method of claim 11, wherein the first tab is connected to the primary section of the first panel and the second tab is connected to the primary section of the last panel.

13. The method of claim 12, wherein the bottom sections of the plurality of panels form a bottom to the container when the container is the in the assembled configuration.

14. A method of forming a container, the method comprising the steps:
forming a plurality of adjacent panels, each panel connected to at least one adjacent panel by a fold line;
forming a first tab, the first tab connected to a first panel of the plurality of panels by a fold line;
forming a second tab, the second tab connected to a last panel of the plurality of panels by a fold line; and
applying an adhesive to one of the first tab and the second tab.

15. The method of claim 14, wherein each the plurality of adjacent panels comprise a primary section, a top section, and a bottom section.

16. The method of claim 15, wherein a primary section of each of said plurality of adjacent panels are connected to at least one adjacent primary section of an adjacent panel by a fold line, and wherein each top and bottom section of each of said plurality of adjacent panels are not connected to an adjacent panel.

17. The method of claim 16, wherein the adhesive is applied to the second tab and a portion of a primary section of the last panel.

18. The method of claim 17, wherein the adhesive is a single, continuous strip of adhesive.

19. The method of claim 17, further comprising: folding the plurality of panels along respective fold lines; aligning a free end of the first panel with a free send of the last panel; and adhering the first tab to the fourth panel and adhering the second tab to the first panel.

20. The method of claim 19, wherein the first tab is adhered to an exterior surface of the fourth panel and the second tab is adhered to an interior surface of the first panel.
